(19) United States
(12) Patent Application Publication
(10) Pub. No.: US 2010/0299057 A1
(43) Pub. Date: Nov. 25, 2010

(54) METHOD AND APPARATUS FOR VERIFYING ROUTE IN ROUTE VERIFICATION SYSTEM

(75) Inventor: Tatsuaki OSAFUNE, Kawasaki (JP)

Correspondence Address: VOLPE AND KOENIG, P.C., UNITED PLAZA, 30 SOUTH 17TH STREET, PHILADELPHIA, PA, 19103, US

(73) Assignee: CLARION CO., LTD., Tokyo (JP)

(21) Appl. No.: 12/784,186

(22) Filed: May 20, 2010

(30) Foreign Application Priority Data
May 22, 2009 (JP) 2009-123698

(51) Int. Cl. G01C 21/36; G08G 1/0969

(52) U.S. Cl. 701/200

(57) ABSTRACT

In a route verification method for verifying a route that allows arrival at a destination in a shortest time, a server obtains, via a network, route information including a starting point and destination of a vehicle having a car navigation device, calculates a route with a shortest required time from the starting point to the destination based on the route information obtained from a plurality of vehicles, and transmits route information with the shortest required time to a terminal device, and the terminal device displays on a display the route with the shortest required time and a route on which the target vehicle runs from the starting point to the destination, wherein the route with the shortest required time is calculated using a link travel time, in the time to be expected that the target vehicle runs, included in the route information obtained from the plurality of vehicles.

### INCORPORATION BY REFERENCE

The present application claims priority from Japanese application JP2009-123698 filed on May 22, 2009, the content of which is hereby incorporated by reference into this application.

### BACKGROUND OF THE INVENTION

The present invention relates to a method and apparatus for verifying a route in a route verification system.

JP-A-2005-345168 (Patent Document 1) discloses a method of storing in a route information memory part the other routes that are not set as a guide route, operating a running simulation of actual running times regarding the other routes from a start point to a destination based on traffic information newly received by a traffic information receiving part when a route guidance is started based on the set guide route, and making capable of comparing a time based on the running simulation result of the other routes that are not set as a guide route with a required time of the set guide route in a car navigation device that searches routes from the starting point to the destination, and sets a route among a plurality of searched routes by indication of an operator as the guide route.

### SUMMARY OF THE INVENTION

The method disclosed in JP-A-2005-345168 (Patent Document 1) has the following problem. That is, when first setting a route as a guide route, another route that is not set as the guide route is selected, and a running simulation is operated with respect to the selected route. Therefore, when a route with an earliest arrival time corresponds to a route except the selected route, the route with the earliest arrival time and the guide route cannot be compared.

Further, traffic information to be obtained is generally delayed with respect to an actual run time.

When comparing a plurality of routes, a best method is to allow a plurality of vehicles to run on different routes toward the same destination at the same time. The comparison accuracy depends on how its conditions can be simulated with accuracy. In the case of traffic information, since it is delayed with respect to the actual run time, when unexpected events such as accidents occur, simulation results are considered to fail to reflect the actual condition in some cases.

To accomplish the above objects, according to one aspect of the present invention, there is provided a method for verifying a route in a route verification system comprising a car navigation device, a server connected to the car navigation device via a network, and a terminal device connected to the server via the network, wherein the server executes the steps of: obtaining route information including a starting point and destination point of a vehicle on which the car navigation device is mounted from the car navigation device via the network; calculating a route with a shortest required time of moving from the starting point to the destination based on the route information obtained from a plurality of vehicles; and transmitting the route information of the route with the shortest required time to the terminal device; and wherein the terminal device executes the step of: displaying on a display a route with the shortest required time and another route from the starting point up to the destination taken by a vehicle on which the car navigation device is mounted; and wherein a route with the shortest required time is calculated using a link travel time at which the vehicle is expected to run, which is included in the route information obtained from the plurality of vehicles.

The route verification method according to the present invention can compare a shortest running route with a route on which a vehicle has actually run and verify them based on the running information of other vehicles collected by a telematics center. Further, the method can compare a minimum fuel consumption route with a route on which the vehicle has actually run.

Other objects, features and advantages of the invention will become apparent from the following description of the embodiments of the invention taken in conjunction with the accompanying drawings.

### BRIEF DESCRIPTION OF DRAWINGS

FIG. 1 is a schematic diagram illustrating a system configuration according to an embodiment.

FIG. 2 illustrates a hardware configuration of a car navigation device according to an embodiment.

FIG. 3 illustrates data items of member information according to an embodiment.

FIG. 4 illustrates data items of vehicle type information according to an embodiment.

FIG. 5 illustrates data items of map information according to an embodiment.

FIG. 6 illustrates data items of statistical traffic information according to an embodiment.

FIG. 7 illustrates data items of probe data according to an embodiment.

FIG. 8 illustrates data items for route verification data according to an embodiment.

FIG. 9 is a flowchart for verifying a route according to an embodiment.

FIG. 10 illustrates a snapshot of a verification route selection screen according to an embodiment.

FIG. 11 illustrates a method for calculating link costs to calculate a shortest time route according to an embodiment.

FIG. 12 illustrates a method for calculating link costs to calculate a route having the minimum fuel consumption amount according to an embodiment.

FIG. 13 illustrates a snapshot displaying a route verification result according to an embodiment.

### DESCRIPTION OF THE EMBODIMENTS

Hereinafter, an embodiment of the present invention will be described.

The present embodiment assumes that a car navigation device is mounted on a vehicle and an owner thereof subscribes to a so-called telematics service which communicates with a center using a wireless communication device such as a cellular phone. Further, the present embodiment assumes that the center is a so-called telematics center and communicates with a plurality of other car navigation devices so as to obtain a plurality of vehicle running data.

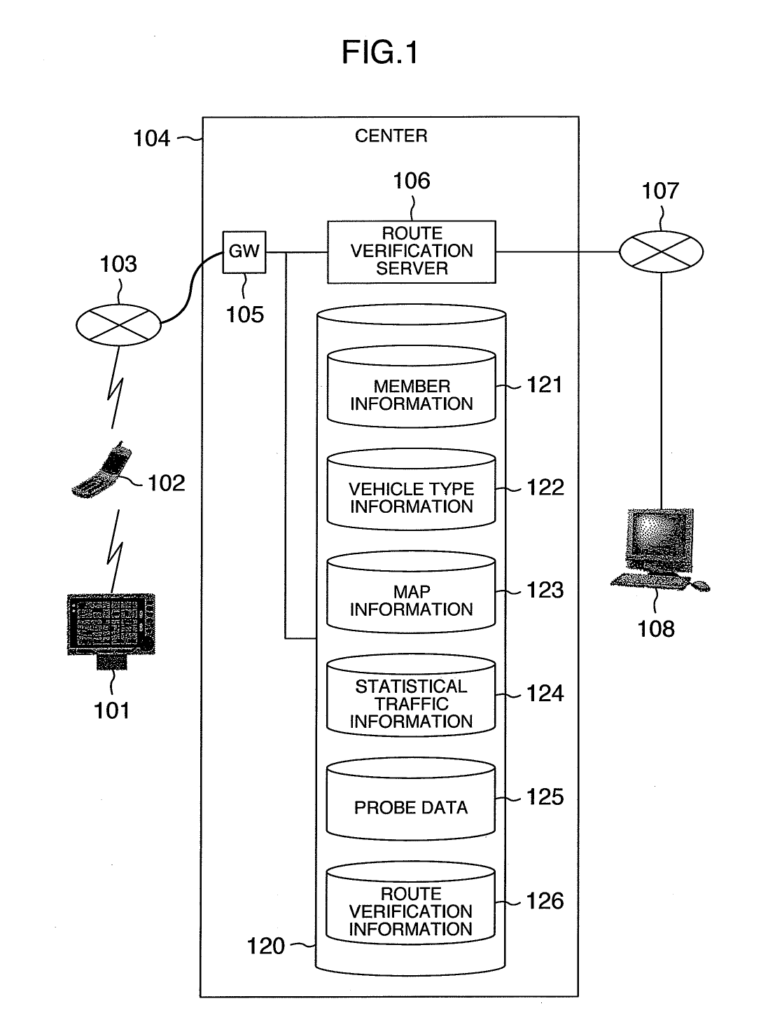

FIG. 1 is the entire configuration diagram according to the present embodiment. A car navigation device 101 connects to a telematics system. Typically, an owner of the car navigation device may can enjoy a telematics service with the car navigation device using a wireless communication device such as cellular phone by subscribing to the service. Here, it is assumed that the owner of the device 101 subscribes to the telematics service. A cellular phone 102 connects to the car navigation device 101 via a short-range wireless communication. The device 101 receives telematics service via this cellular phone 102. A network 103 is used for performing communication via the cellular phone, which is typically a cellular phone network. The cellular phone 102 communicates with the telematics center via the network 103.

A telematics center 104 includes a GW 105, a route verification server 106, and a database 120. The database 120 stores a variety of data including member information 121 i.e. contract member information of telematics service, vehicle type information 122, map information 123, statistical traffic information 124, probe data 125 which is identical to a plurality of vehicle running data, and route verification information 126.

Further, the route verification server 106 includes a CPU serving as a controller, a memory such as hard disk for storing a route verification program, a communication unit for communicating with the car navigation device 101 and a PC 108 via the network, and an interface for accessing the database 120 to obtain a variety of data (not shown).

A network 107 is used for communicating from outside with the route verification server 106. The PC 108 is connected to the network 107 and thus can communicate with the route verification server 106 via the network 107.

Here, it is noted that although FIG. 1 illustrates a scheme in which the car navigation device 101 is connected to the cellular phone 102 and communicates with the route verification server 106, the car navigation device 101 may include a communication unit therein for connecting to a cellular phone network or any other suitable network.

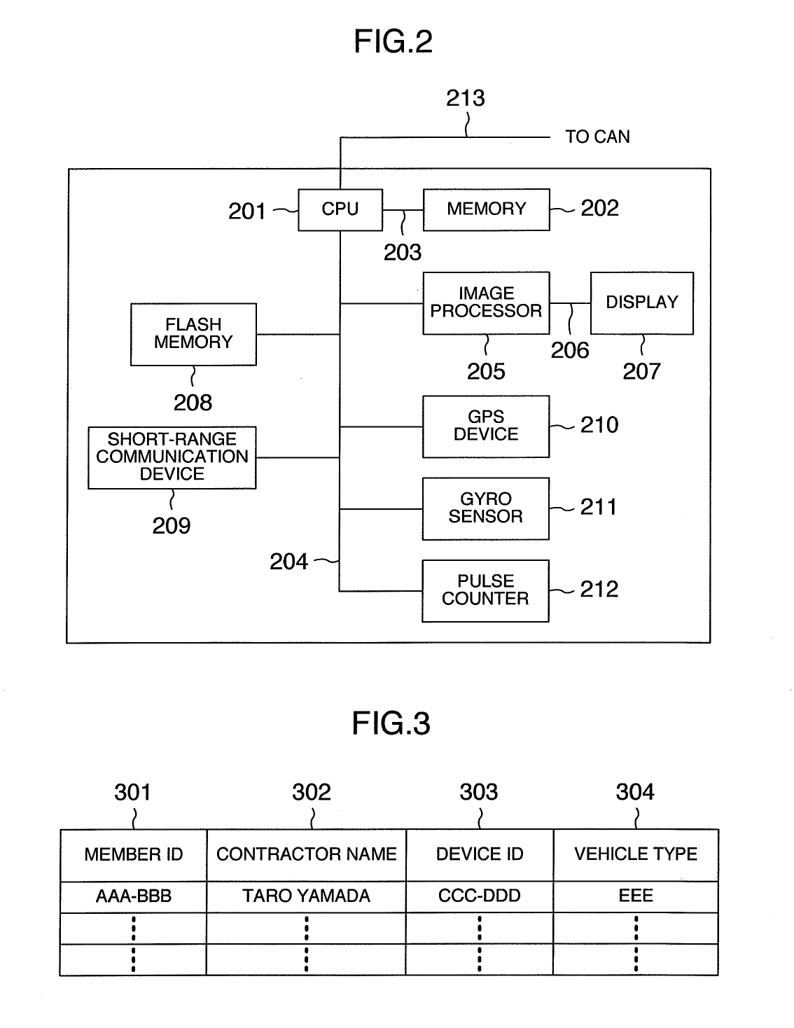

FIG. 2 is a hardware configuration diagram of the car navigation device 101 according to the present embodiment. The CPU 201 and a memory 202 of the device 101 are connected via a signal line 203 such as a bus. The CPU 201 is connected to each of the following devices via another signal line 204 such as a bus. The image processor 205 is connected to a display 207 via a cable 206. Here, the image processor 205 performs a calculation for drawing maps etc. necessary for the navigation and transmits a drawing signal to the display 207 via the cable 206. The flash memory 208 is used to store map information etc. The short-range communication device 209 performs wireless communication and serves as transmitting and receiving data transmitted and received via the signal line 204 to and from an external device using wireless communication. By receiving and analyzing GPS signals, a GPS device 210 obtains position information of the vehicle and the exact current time, and transmits and receives data to and from the signal line 204. Various sensors such as a gyro sensor 211 and a pulse counter 212 are connected to the signal line 204. Various ECUs of a vehicle are connected to the CAN bus 213, and therefore the car navigation device 101 can obtain the speed and fuel consumption of the vehicle.

FIG. 3 illustrates a member information table included in the member information 121 according to the present embodiment. According to the present embodiment, AAA-BBB is registered as a member ID 301. Also, “Taro Yamada” is registered as a contractor name 302. Further, CCC-DDD and EEE are registered as a device ID 303 and a vehicle type 304, respectively.

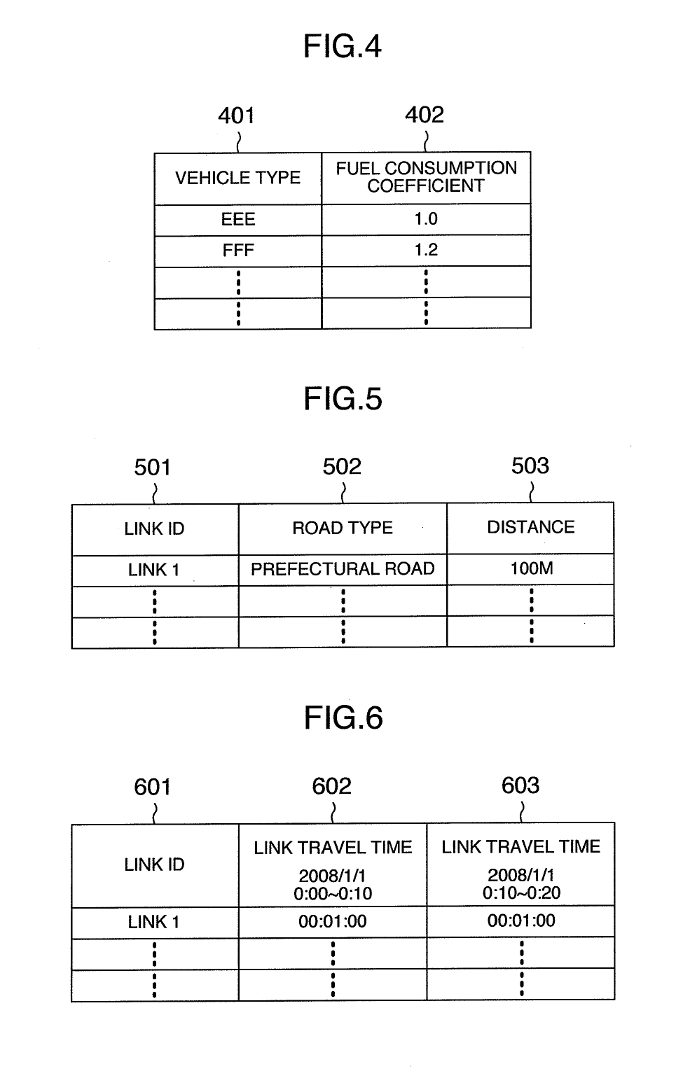

FIG. 4 illustrates a vehicle type information table included in the vehicle type information 122 according to the present embodiment. This table includes a vehicle type 401 and a fuel consumption coefficient 402. In this example, EEE and FFF are registered as the vehicle type. Further, the coefficients 402 of EEE and FFF are set to 1.0 and 1.2, respectively. These coefficients represent a target measure of the fuel consumption amount consumed per unit distance. FIG. 3 shows that FFF is larger by 20% than EEE in the fuel consumption amount.

FIG. 5 illustrates a map information table included in the map information 123 according to the present embodiment. The data items of this table are a link ID 501 which is an identifier for specifying one of links representative of a position element of a road constituting a map, a road type 502 indicating the type of the link, and a distance 503 indicating the length of the link. According to the present embodiment, LINK 1, a prefectural road, and 100 meter are stored as the link ID 501, the road type 502, and the distance 503, respectively.

FIG. 6 illustrates a statistical traffic information table included in the statistical traffic information 124 according to the present embodiment. This table includes a link ID 601 and a link travel time. In this example, the table shows that both of the link travel time 602 of 00:00 to 00:10, Jan. 1, 2008 and the link travel time 603 of 00:10 to 00:20, Jan. 1, 2008 take one minute. In the table, link travel times of all of the links of the map information are illustrated in FIG. 5. Further, according to the present embodiment, the link travel time will be stored for one month, and the link travel time of January in 2008 is stored at ten minutes intervals.

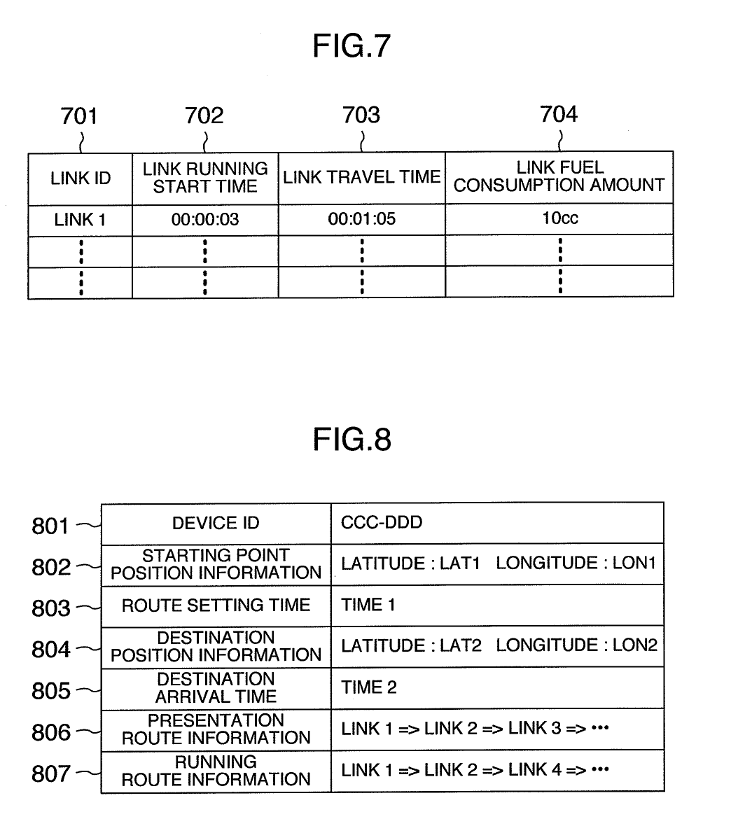

FIG. 7 illustrates a probe data table included in the probe data 125 according to the present embodiment. This table is comprised of a link ID 701, a link running start time 702, a link travel time 703, and a link fuel consumption amount 704. Each of the data is generated in each vehicle and then transmitted to the telematics center 104 and stored in the probe data table 125. According to the present embodiment, LINK 1, 00: 00: 03 (0: 0, 3 seconds), 00: 01: 05, 10 cc, and EEE are registered as the link ID 701, the link running start time 702, the link travel time 703, the link fuel consumption time 704, and the vehicle type, respectively.

FIG. 8 illustrates a route verification data table included in the route verification data 126 according to the present embodiment. Data included in this table is to be transmitted to the telematics center 104 from the car navigation device 101 mounted on the vehicle. Also, after setting the destination, the data will be transmitted when the device 101 arrives at the destination. This data is stored as the route verification information 126 in the database 120 of the telematics center 104. According to the present embodiment, the following data will be transmitted from the car navigation device 101.

A device ID 801 is used for identifying the car navigation device. A vehicle position 802 is the starting position indicating the position of the vehicle at the time when a driver sets a destination with the car navigation device. This position is comprised of the latitude and longitude of the vehicle calculated from GPS signals. A route setting time 803 indicates the time when the driver sets the destination with the car navigation device. Destination position information 804 indicates the latitude and longitude of the destination set by the driver. The time 805 indicates the time when the driver reaches the destination. A route 806 indicates a route presented by the car navigation device when the driver searches for a route with the car navigation device. This route is defined as a sequence of link data, and FIG. 8 illustrates links constituting the obtained route and the order of the links. A route 807 is running route information of a route on which the vehicle has actually run, that is, running route information. Similar to the route information presented by the device, the data is also defined as a sequence of the link data. FIG. 8 illustrates links constituting the route on which the vehicle has actually run and the order of the links.

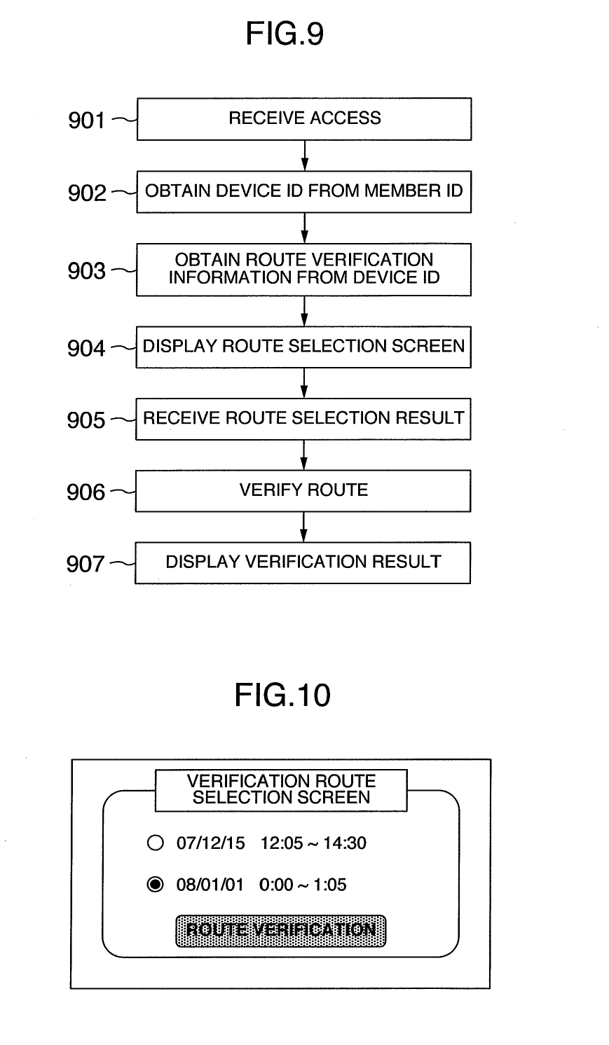

FIG. 9 illustrates a flowchart for verifying routes according to the present embodiment. This flowchart represents the operation of programs executed by the route verification server 106. When a user requests the telematics center 104 to verify routes according to the flowchart, the route can be displayed in a comparative manner. This program is stored in a memory of the route verification server 106 in the telematics center 104. A CPU, which is a controller of the server 106, reads the program from the memory and executes it. When the routes are verified, the route verification server 106 obtains various data stored in the database 120 and performs the route verification. Operations for performing the verification will be described in detail below with reference to FIGS. 9 to 12. Although these drawings will be described with the server 106 as an agent of action, the CPU may execute the program in practice as described above.

First, the flowchart starts by receiving user access (step 901). The user accesses the route verification server 106 via the network 107 from the PC 108. Further, the user has the user ID of the subscribing telematics service and transmits the user ID to the route verification server 106 using HTTP cookies on the access. Therefore, the route verification server 106 can determine which user accesses to the server by checking the member information 121.

Next, the route verification server 106 obtains the device ID from the member ID (step 902). Using the previously obtained user ID, the route verification server 106 searches the member information 121 illustrated in FIG. 3 to identify the device ID 303 from the member ID 301. By obtaining the device ID in this manner, the route verification server 106 can determine which car navigation devices the accessing user currently owns.

Next, the route verification server 106 searches the route verification data table illustrated in FIG. 8 using the device ID and obtains the route verification information of the user (step 903).

At this time, there may be a plurality of route verification information and therefore the route verification server 106 displays the route selection screen as illustrated in FIG. 10 (step 904). The screen displays all of the route verification information of the user in the route verification information 126 stored in the database 120. Each route has several driving times and the user can select a route to be verified based on the specified driving time. It is noted that the route verification server 106 can identify the driving route for each user by referring to the member ID and device ID of the member information 121, and the device ID and driving route information of the route verification information 126.

When the user selects a route to be verified, the route information will be transmitted to the route verification server 106, which in turn receives the route selection results (step 905).

Next, the route verification server 106 performs route verification based on the route verification information (step 906). In the verification, among the routes between a starting point and a destination point at the departure time, a route having the minimum arrival time and a route having the minimum fuel consumption are obtained based on the map information 123 illustrated in FIG. 5, the statistical traffic information 124 illustrated in FIG. 6, and the probe data 125 illustrated in FIG. 7, using the starting point data 802, departure time (route setting time) 803, and destination position data 804 of the selected route.

Although the above-described routes are calculated using a Dijkstra method, the present embodiment differs from the method in calculating link costs. Hereinafter, the method for calculating the link costs will be described, specifically.

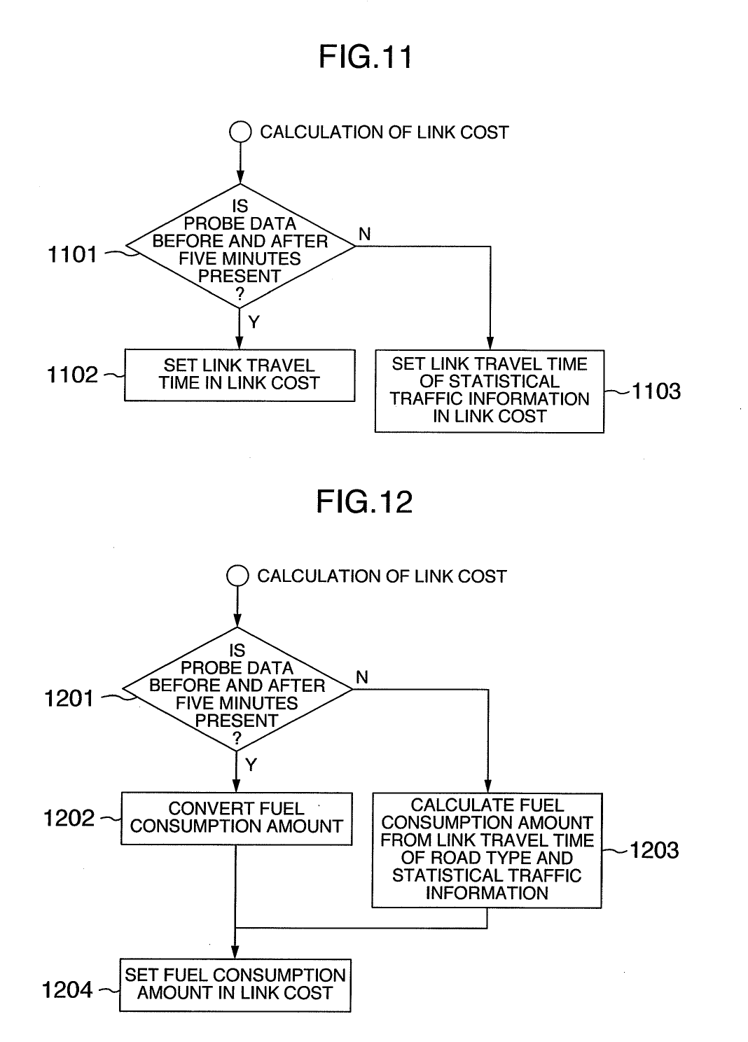

FIG. 11 is a flowchart illustrating the link cost calculating method for calculating the shortest time route according to the present embodiment. For the purpose of calculating the shortest time route using the Dijkstra method, the route verification server 106 may add the link travel time up to an adjacent point from a certain point via the link and find a route in which the sum of the link travel times is minimized. To cope with the above-described situation, when calculating the link cost, the route verification server 106 first searches for the route from the probe data 125 before and after five minutes from a certain point (step 1101).

If data is present, since the link travel time is written in the data as illustrated in FIG. 7, the route verification server 106 sets a value of the data as the link cost (step 1102). If two or more appropriate data blocks are present, the route verification server 106 sets an average of the link travel times as the link cost.

If the data before and after five minutes from a certain point is absent in the probe data 125, since the statistical traffic information as illustrated in FIG. 6 is registered as the link travel time in the appropriate time, the route verification server 106 sets the link travel time as the link cost (step 1103).

When repeating the search up to the destination with the link cost using the Dijkstra method, the route verification server 106 can calculate the arrival time in each point and determine the route that allows the arrival at the destination in the shortest time. Here, as the conditions of searching the probe data, the data before and after five minutes from a certain point is set. However, this value of the time is a parameter to be adjusted considering the amount of the probe data and the required accuracy. Therefore, the value may be an arbitrary one. In the case where this value is large, since the possibility that the probe data is hit in the search is raised, a route verification result using actual data is easy to be obtained. On the other hand, the accuracy of the data is possibly lowered due to a difference of the time. When this value is reduced, the possibility that the probe data is hit in the search is lowered. If the value of the time is extremely made short, the probe data is not found at all. Therefore, since searching only the statistical traffic information for the shortest time route, the route verification server 106 obtains the same route as that to be searched by the car navigation device 101. The time distance for the search conditions has to be adjusted according to the amount of the probe data.

FIG. 12 is a flowchart illustrating the link cost calculating method for calculating the shortest time route according to the present embodiment. For the purpose of calculating a route in which the fuel consumption amount is minimized using the Dijkstra method, the route verification server 106 may add the fuel consumption amount up to an adjacent point from a certain point via the link, and find a route in which the sum of the fuel consumption amount is minimized. To cope with the above-described situation, the route verification server 106 first searches the probe data 125 before and after five minutes from a certain point for the minimum fuel consumption route in the same manner as well as calculating the shortest time route (step 1201).

If data is present, the fuel consumption amount is written in the data as illustrated in FIG. 7. Since the fuel consumption amount is significantly different from other vehicles depending on the vehicle type, the fuel consumption amount written in the data is converted into that of the appropriate vehicle type using the fuel consumption coefficient written in the vehicle type information 122 illustrated in FIG. 4. Suppose, for example, that the link fuel consumption amount written in the probe data is 10 cc, the fuel consumption coefficient of the vehicle type written in the probe data is 1.2, and the fuel consumption coefficient of the vehicle type of the user is 0.8. In the above-described case, the route verification server 106 calculates 10 cc×1.2×0.8=9.6 cc as the link cost (step 1202), and sets its value as the link cost (step 1204).

Further, if data before and after five minutes from a certain point is absent in the probe data 125, the route verification server 106 calculates the fuel consumption amount based on the link travel time of the road type and the statistical traffic information (step 1203). As to this calculating method, the route verification server 106 may use the same calculation method as that of the car navigation device.

The route verification device 106 sets the calculated fuel consumption amount as the link cost (step 1204).

If the actual vehicle running data is present, its data is preferentially used. When thus performing the above-described method, the route verification server 106 can calculate the high-accuracy shortest time route and minimum fuel consumption route as compared with the case of using actual data.

The data on the shortest time route and minimum fuel consumption route that are calculated using the above-described calculating method is transmitted to the car navigation device 101 from the route verification server 106 via the network. The car navigation device 101 displays the verification results using the transmitted calculation results (step 907). Specifically, the car navigation device 101 displays the shortest time route or the minimum fuel consumption route on the display, or alternatively, the car navigation device 101 displays both of the shortest time route and the minimum fuel consumption route on the display.

Here, there is described the example in which the route verification server 106 transmits the calculation results to the car navigation device 101; further, the route verification server 106 may transmit the data on the calculated shortest time route and minimum fuel consumption route to the PC 108 via the network. In this case, the PC 108 displays the shortest time route or the minimum fuel consumption route on the display, or alternatively, the PC 108 displays both of the shortest time route and the minimum fuel consumption route on the display.

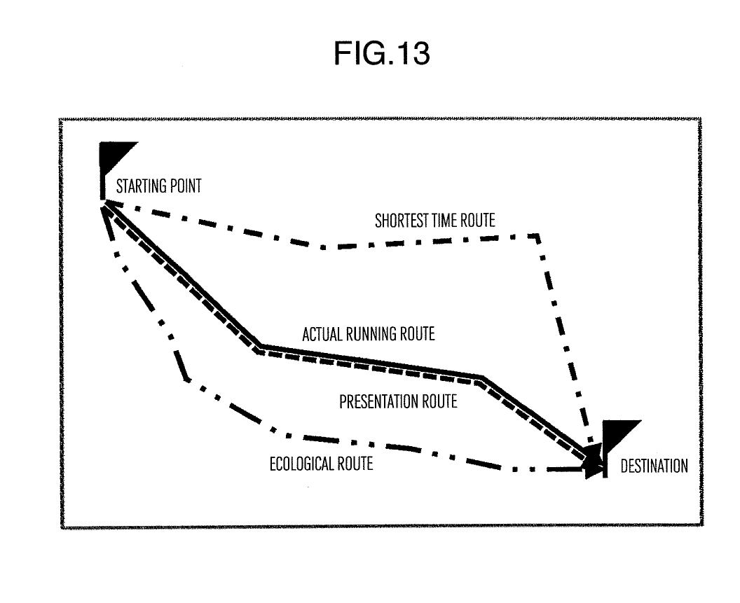

FIG. 13 illustrates a display image of the verification results.

FIG. 13 illustrates four routes from the starting point to the destination. The first route is a route on which a vehicle has actually run. The second route is a route that is first presented to the user as the search result by the car navigation device 101. The third route is the shortest time route. The fourth route is the minimum fuel consumption route, that is, an ecological route. By thus illustrating the above-described routes, the user can determine whether to select which route when a vehicle runs on a route next time.

It should be further understood by those skilled in the art that although the foregoing description has been made on embodiments of the invention, the invention is not limited thereto and various changes and modifications may be made without departing from the spirit of the invention and the scope of the appended claims.

1. A method for verifying a route in a route verification system comprising a car navigation device, a server connected to the car navigation device via a network, and a terminal device connected to the server via a network, the method causing:
the server to execute the steps of:
obtaining route information including a starting point and destination of a vehicle on which the car navigation device is mounted from the car navigation device via the network;
calculating a route with a shortest required time at the time of moving from the starting point to the destination based on the route information obtained from a plurality of vehicles; and
transmitting the route information on the route with the shortest required time to the terminal device; and
the terminal device to execute the step of:
displaying on a display the route with the shortest required time and a route at the time when a vehicle on which the car navigation device is mounted runs from the starting point up to the destination;
wherein the route with the shortest required time is calculated using a link travel time, in the time to be expected that the vehicle runs, included in the route information obtained from the plurality of vehicles.

2. The method according to claim 1, wherein:
the link travel time is a run time at the time when a vehicle that runs on a section of a route from the starting point to the destination runs on the section.

3. The method according to claim 1, wherein:
the link travel time is a run time of a vehicle that runs on the section within five minutes before and after the time to be expected that the vehicle runs.

4. The method according to claim 1, wherein:
the link travel time is a run time calculated from statistical traffic information at the time when no vehicle runs on the section within five minutes before and after the time to be expected that the vehicle runs.

5. The method according to claim 1, wherein:
a route with the shortest required time is a route in which a total added value of a link travel time from the starting point to the destination is minimized.

6. A method for verifying a route in a route verification system comprising a car navigation device, a server connected to the car navigation device via a network, and a terminal device connected to the server via a network, the method causing:
the server to execute the steps of:
obtaining route information including a starting point and destination of a vehicle on which the car navigation device is mounted from the car navigation device via the network;
calculating a route with minimum fuel consumption at the time of moving from the starting point to the destination based on the route information obtained from a plurality of vehicles; and
transmitting the route information on the route with the minimum fuel consumption to the terminal device; and
the terminal device to execute the step of:
displaying on a display a route with the minimum fuel consumption and a route at the time when a vehicle on which the car navigation device is mounted runs from the starting point to the destination;
wherein a route with the minimum fuel consumption is calculated using a link fuel consumption amount, in the time to be expected that the vehicle runs, included in the route information obtained from the plurality of vehicles.

7. The method according to claim 6, wherein:
the link fuel consumption amount is a fuel consumption amount at the time when a vehicle that runs on a section of a route from the starting point to the destination runs on the section.

8. The method according to claim 6, wherein:
the link fuel consumption amount is a fuel consumption amount of a vehicle that runs on the section within five minutes before and after the time to be expected that the vehicle runs.

9. The method according to claim 6, wherein:
the link fuel consumption amount is a fuel consumption amount calculated from statistical traffic information at the time when no vehicle runs on the section within five minutes before and after the time to be expected that the vehicle runs.

10. The method according to claim 6, wherein:
the link fuel consumption amount is corrected for each vehicle type.

11. The method according to claim 6, wherein:
a route with the minimum fuel consumption is a route in which a total added value of a link fuel consumption amount from the starting point to the destination is minimized.

12. An apparatus for verifying a route in a route verification system comprising:
a car navigation device;
a server connected to the car navigation device via a network; and
a terminal device connected to the server via a network,
wherein said server obtains route information including a starting point and destination of a vehicle on which the car navigation device is mounted from the car navigation device via the network, calculates a route with a shortest required time at the time of moving from the starting point to the destination based on the route information obtained from a plurality of vehicles, and transmits the route information on the route with the shortest required time to the terminal device;
wherein said terminal device displays on a display the route with the shortest required time from the server and a route at the time when a vehicle on which the car navigation device is mounted runs from the starting point up to the destination; and
wherein the route with the shortest required time is calculated using a link travel time, in the time to be expected that the vehicle runs, included in the route information obtained from the plurality of vehicles.
